(19) United States
(12) Patent Application Publication
(10) Pub. No.: US 2015/0318990 A1
(43) Pub. Date: Nov. 5, 2015

(54) DEVICE AND METHOD FOR TRANSMITTING DATA IN AN ENCRYPTED FORM

(71) Applicant: SAGEMCOM DOCUMENTS SAS, Rueil Malmaison (FR)

(72) Inventor: Jérome BERGER, RUEIL-MALMAISON (FR)

(21) Appl. No.: 14/443,113

(22) PCT Filed: Nov. 13, 2013
(86) PCT No.: PCT/EP2013/073703

§ 371 Date: May 15, 2015

(30) Foreign Application Priority Data
Nov. 16, 2012 (FR) 12/60923

(51) Int. Cl. H04L 9/30; H04L 9/32

(52) U.S. Cl. CPC H04L 9/30; H04L 9/3239

(57) ABSTRACT

A control device controlling a device obtains a key that is supposed to be a public encryption key of a device recipient of data is to be transmitted in encrypted form. The control device obtains information derived from the public encryption key of the recipient device, and checks the obtained key, thanks to said information derived from the public encryption key of the recipient device. The control device authorises or prohibits the communication device from transmitting the data in encrypted form thanks to the obtained key, according to said checking.

The present invention concerns a transmission of encrypted data from a communication device to a recipient device.

There exist simple solutions, such as emails and IP (Internet Protocol, as defined in the normative document RFC 791) faxing solutions for transmitting data via a communication network. They do not however guarantee confidentiality of the data transmitted since these data transit in clear over the public network and therefore any person having access to the network infrastructures can intercept these data. This concerns in particular email servers that act as intermediaries between a data source device and a data recipient device, as well as routers.

In order to ensure confidentiality of the data transmitted via the communication network, there exist asymmetric encrypting solutions based on the use of public keys and private keys, such as OpenPGP as defined in the normative document RFC 4880, which enable encrypting and electronically signing the transmitted data. The encryption ensures that only the recipient of the data can decipher the data and the signature guarantees the identity of the device that transmitted the data. However, these solutions require setting up complex architecture and require trusting a third party who is responsible for distributing and guaranteeing the authenticity of the encryption keys.

In addition, there exists no reliable solution for verifying the correct transmission of the data to their recipient. The header of an email may contain a field X-Confirm-Reading-To, Disposition-Notification-To or Return-Receipt-To, but this header format is not systematically complied with and the acknowledgement may easily be falsified.

It is therefore desirable to overcome these drawbacks of the prior art and in particular to guarantee that a key received by a first communication device is actually the public encryption key used by a second communication device to which the first communication device must transmit data in encrypted form. It is also desirable to provide a solution that guarantees that the encrypted data transmitted by the first communication device are actually received by the second communication device. It is also desirable to provide a solution that is simple to implement, in particular in terms of architecture.

The invention concerns a method for deciding on transmission of encrypted data to a recipient device, the method being implemented by a control device controlling a communication device, said method comprising the following step: obtaining a key that is supposed to be a public encryption key of said recipient device. The method is such that it further comprises the following steps: obtaining information derived from the public encryption key of said recipient device; checking the obtained key, thanks to said information derived from the public encryption key of said recipient device; authorising or prohibiting transmission of said data, encrypted thanks to the obtained key, according to said checking. Thus the confidentiality of the data is guaranteed without having recourse to a trusted third party. In addition, the information derived from the public encryption key ensures that a malicious device cannot pass itself off as the device receiving the data by sending its own key to the communication device.

According to a particular embodiment, the step of obtaining the key that is supposed to be the public encryption key of said recipient device comprises the following steps: transmitting to a key server device said information derived from the public encryption key of said recipient device, the key server device storing information on matching between public encryption keys and information respectively derived from said public encryption keys; receiving, in response, the key supposed to be the public encryption key of said recipient device.

According to a particular embodiment, the key supposed to be the public encryption key of said recipient device is received in conjunction with information for addressing the recipient device.

According to a particular embodiment, the step of obtaining the key supposed to be the public encryption key of said recipient device comprises the following steps: transmitting to the recipient device a request for obtaining the public encryption key of said recipient device; receiving, in response, the key supposed to be the public encryption key of said recipient device.

According to a particular embodiment, the information derived from the public encryption key of said recipient device is derived from a fingerprint of the public encryption key of said destination device.

According to a particular embodiment, the control device is included in the communication device.

The invention also relates to a method for transmitting encrypted data, to a device recipient of said encrypted data, by a communication device. The transmission method is such that the communication device implements the decision method previously mentioned and performs the following steps: transmitting encrypted data the case of positive checking of the key supposed to be the public encryption key of said recipient device; receiving a signed acknowledgement; checking the signed acknowledgement, using the key supposed to be the public encryption key of said recipient device.

The invention also relates to a control device controlling a communication device, the control device comprising: means for deciding on transmission of encrypted data to a device recipient of said encrypted data; means for obtaining a key supposed to be a public encryption key of said recipient device. The control device is such that it further comprises: means for obtaining information derived from the public encryption key of said recipient device; means for checking the obtained key, thanks to said information derived from the public encryption key of said recipient device; and means for authorising or prohibiting transmission of said data, encrypted thanks to the obtained key, according to said checking.

The invention also relates to a computer program, which may be stored on a medium and/or downloaded from a communication network, in order to be read by a processor. This computer program comprises instructions for implementing the method mentioned above, when said program is executed by the processor. The invention also relates to storage means comprising such a computer program.

The features of the invention mentioned above, as well as others, will emerge more clearly from a reading of the following description of an example embodiment, said description being given in relation to the accompanying drawings, among which:

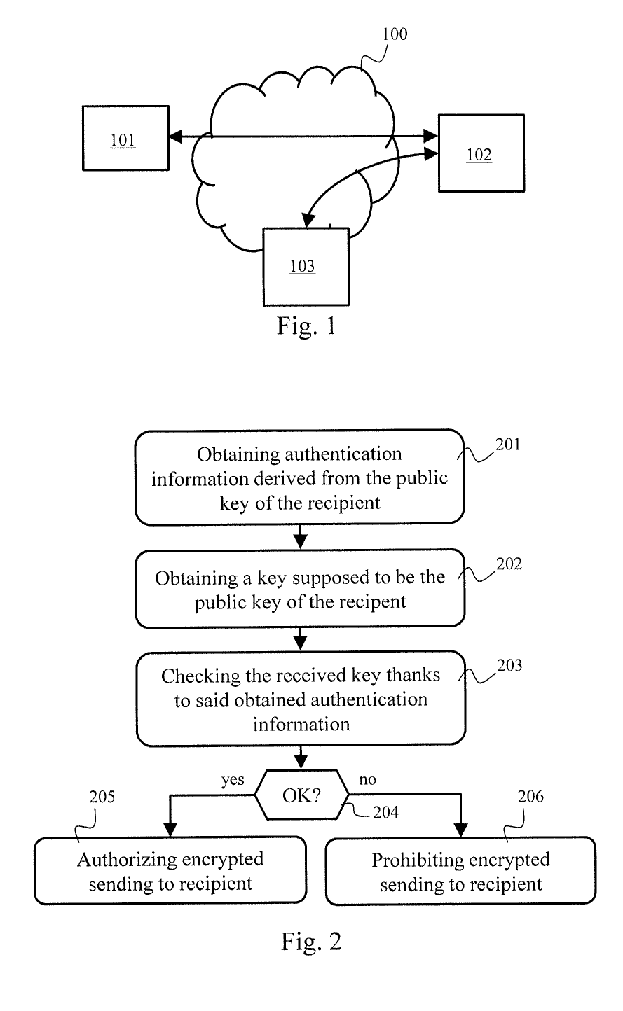

FIG. 1 schematically illustrates a system in which the invention may be implemented;

FIG. 2 schematically illustrates an algorithm for establishing a sending of encrypted data;

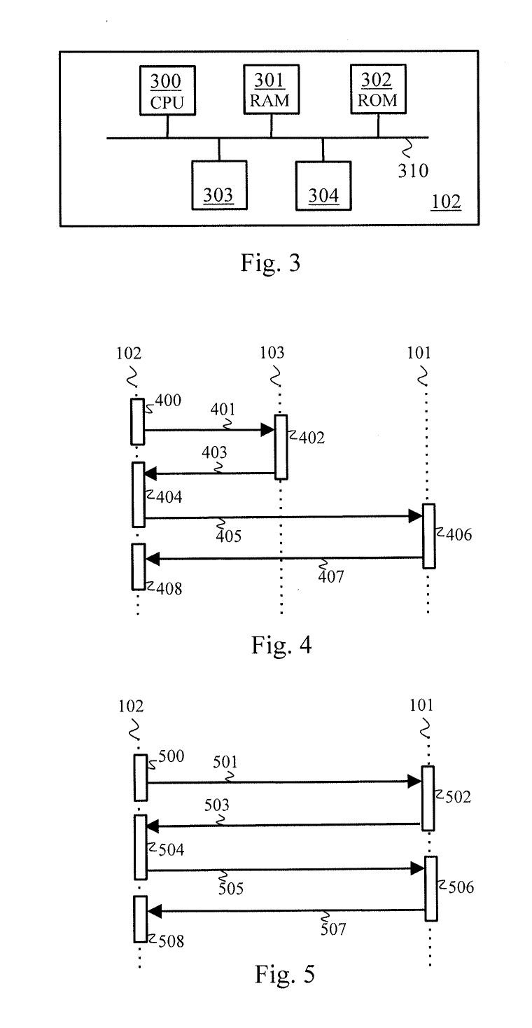

FIG. 3 schematically illustrates an example of hardware architecture of a communication device of the system of FIG. 1;

FIG. 4 schematically illustrates a first example of exchanges in the context of a sending of encrypted data;

FIG. 5 schematically illustrates a second example of exchanges in the context of a sending of encrypted data.

FIG. 1 schematically illustrates a system in which the invention may be implemented. The system of FIG. 1 comprises a first communication device 101 and a second communication device 102. The first 101 and second 102 communication devices are interconnected by a communication network 100, such as the Internet.

We consider hereinafter the case where the communication device 102 must transmit data in encrypted form to the communication device 101.

The first 101 and second 102 communication devices are for example personal computers (PCs), fax machines or any other machine adapted for sending data in encrypted form to another machine recipient of these data.

So as to exchange data in encrypted form, the first 101 and second 102 communication devices each have a public encryption key and a private encryption key, thus using an asymmetric cryptographic mechanism. The public key of a communication device is intended to be disseminated and the private key is intended to be kept secret by the communication device by any suitable means. Preferably, the public key and the private key are generated by the communication device itself. By applying a method detailed below, any communication device is capable of determining authentication information derived from a public key using said public key.

The system may further comprise a key server device 103. The key server device 103 stores information on matching between on the one hand public keys and on the other hand authentication information derived from the public keys. Thus, when a communication device supplies, via the network 100, authentication information derived from a public key, the key server device 103 in return supplies the public key that corresponds to the supplied authentication information. The key server device 103 may also store information on addressing of the communication devices with which the public keys are associated and the authentication information respectively derived from said public keys. Thus, when a communication device supplies, via the network 100, authentication information derived from a public key, the key server device 103 in return supplies the public key that corresponds to the supplied authentication information, as well as the addressing information for the communication device associated with said public key and the supplied authentication information.

When a communication device such as the communication device 101 connects to the network 100, this communication device gets into contact with the key server device 103 in order to supply to the key server device 103 the public encryption key of said communication device. The communication device may also supply the authentication information derived from the public key; in a variant, the key server device 103 may determine the authentication information derived from the public key, applying the same method as the one applied by the communication device. The communication device may also supply the addressing information enabling it to be contacted, whether this is an email address, a telephone or fax number or an IP address. The key server device 103 may also determine this addressing information from packet header fields transmitted from the communication device to the key server device 103.

In another embodiment, the matching information stored by the key server device 103 may be pre-established.

FIG. 2 schematically illustrates an algorithm for setting up a sending of encrypted data by the communication device 102 to the communication device 101 via the network 100. The algorithm of FIG. 2 is implemented by a device controlling the communication device 102. It is preferably considered hereinafter that the control device is included in the communication device 102.

In a step 201, the communication device 102 obtains authentication information derived from the public encryption key of the communication device 101. This information may be stored in the memory of the communication device 102 and read by the communication device 102. This information may also be obtained via a user interface, via which a user enters said information. For example, a user of the communication device 101 indicates this information on a business card that he/she distributes to the user of the communication device 102. The user of the communication device 101 may also disseminate his information through another communication channel, such as for example via email or SMS (Short Message Service). This information may be supplied by the communication device 101 to the user, for example by display on a screen of the communication device 101. Thus, when the user enters said authentication information derived from the public key, the user indirectly designates the recipient of the sending of encrypted data. This designation by said authentication information may be used to obtain or recover addressing information enabling making contact with said recipient.

Preferably, the authentication information derived from the public encryption key of the communication device 101 is the result of applying a predefined injective function to the public encryption key of the communication device 101.

According to a particular embodiment, the authentication information derived from the public encryption key of the communication device 101 is a fingerprint of said public key, meaning said information is obtained by applying a hash function to said public encryption key. Hash functions of the MD5 (Message Digest 5) type, or of the SHA (Secure Hash Algorithm) type such as SHA-1 or SHA-256, may be implemented. Ordinarily, such a fingerprint is used to check the integrity of the received public key, in order for example to detect corruption of data during transfer of said public key. In the present case, this fingerprint is used to authenticate the fact that the received public key does indeed correspond to the one expected, meaning the public encryption key of the communication device 101. This is related to the fact that the authentication information derived from the public encryption key of the communication device is received independently of the public key itself.

According to another particular embodiment, the information derived from the public encryption key of the communication device 101 is derived from a fingerprint of said public key. This information may then be a transposition of the fingerprint in a data base, or a truncated version of the fingerprint.

The authentication information derived from the public encryption key of the communication device 101 may then be represented in the form of a string of alphanumeric, hexadecimal, etc characters.

The authentication information derived from the public encryption key of the communication device 101 is hereinafter referred to as SAS string (Short Authentication String).

In a step 202, the communication device 102 obtains a key supposed to be the public encryption key of the communication device 101. In a first embodiment detailed below in relation FIG. 4, the communication device 102 obtains this key upon request addressed to the key server device 103. In a second embodiment detailed below in relation to FIG. 5, the communication device 102 obtains this key upon request addressed to the communication device 101.

It should be noted that the steps 201 and 202 may be reversed. In other words, obtaining the authentication information derived from the public encryption key of said recipient device is done independently of obtaining the key supposed to be the public encryption key of said recipient device.

In a following step 203, the communication device 102 checks the authenticity of the key obtained at the step 202. Indeed, the request to obtain the public encryption key of the communication device 101 may have been intercepted by a device controlled by a malicious user and the key received at the step 202 may not be the public encryption key of the communication device 101. The communication device 102 then checks the key obtained at the step 202, using the SAS string. The communication device 102 applies the function that enables obtaining an SAS string from a key. Preferably, the communication device 102 applies the predefined injective function and checks that the obtained result is equal to the SAS string.

In a following step 204, the communication device 102 determines whether the result of the check made at the step 203 is positive. If such is the case, a step 205 is performed; otherwise a step 206 is performed.

In the step 205, the communication device 102 decides to authorise a data transmission, encrypted thanks to the key obtained at step 202, toward the communication device 101.

In the step 206, the communication device 102 decides to prohibit the data transmission, encrypted thank to the key obtained at the step 202, toward the communication device 101.

FIG. 3 schematically illustrates an example of hardware architecture of the communication device 102, which then comprises, connected by a communication bus 310: a processor or CPU (Central Processing Unit) 300; a random access memory RAM 301; a read only memory ROM 302; a storage reader or storage medium reader such as a hard disc drive HDD 303; an interface 304 for communicating via the network 100.

The processor 300 is capable of executing instructions loaded into the RAM 301 from the ROM 302, an external memory (not shown), a storage medium such as a hard disc drive HDD 303, or the network 100. When the communication device 102 is powered up, the processor 300 is capable of reading instructions from the RAM 301 and executing them. These instructions form a computer program causing the implementation, by the processor 300, of all or some of the algorithms and steps described in relation to FIGS. 2, 4 and 5. All or some of the algorithms and steps described in relation to FIGS. 2, 4 and 5 may be implemented in software form by execution of a set of instructions by a programmable machine, such as a DSP (Digital Signal Processor) or a microcontroller, or be implemented in hardware form by a machine or a dedicated component, such as an FPGA (Field-Programmable Gate Array) or an ASIC (Application-Specific Integrated Circuit).

FIG. 4 schematically illustrates a first example of exchanges in the context of a sending of encrypted data by the communication device 102 toward the communication device 101 via the network 100.

In a step 400, the communication device 102 obtains the SAS string associated with the communication device 101, for example following entry of the SAS string by a user via a user interface of the communication device 102.

In a following step 401, the communication device 102 transmits, to the key server device 103, a request aiming at obtaining the public encryption key of the communication device 101. The request comprises the SAS string obtained at the step 400. Upon reception of the request, in a following step 402, the key server device 103 retrieves the public encryption key of the communication device 101 thanks to the SAS string supplied by the communication device 102, using the previously mentioned matching information.

It should be noted here that the information derived from the public key, meaning the SAS string, is obtained before the public key is required. In other words, the authentication information derived from the public encryption key of said recipient device is obtained independently of obtaining the key supposed to be the public encryption key of said recipient devices.

In a following step 403, the key server device 103 transmits the retrieved public key to the communication device 102, in response to the request transmitted at the step 401. The key server device 103 may also conjointly transmit information for addressing the communication device 101, to enable the communication device 102 to address data to the communication device 101.

In a following step 404, the communication device 102 checks the authenticity of the key received at the step 403, as described above in relation to FIG. 2. In case of positive checking, the communication device 102 encrypts the data to be transmitted to the communication device 101 thanks to the key obtained at the step 403.

In a following step 405, the communication device 102 then transmits the data thus encrypted to the communication device 101. Preferably, the communication device 102 signs the sending of the encrypted data thanks to its own private key. The communication device 102 may conjointly or separately transmit its own public key to the communication device 101. In a variant, the communication device 101 may obtain the public key of the communication device 102 from the key server device 103, thanks to the SAS string associated with the public key of the communication device 102.

In a following step 406, the communication device 101 decodes the data received from the communication device 102 thanks to its own private key. Preferably, the communication device 101 checks the authenticity of the received and decoded data, by checking the validity of the signature of the received data, thanks to the public key of the communication device 102.

In a following step 407, the communication device 101 acknowledges the received data. Preferably, the acknowledgement transmitted to the communication device 102 is signed by the communication device 101 thanks to its own private key. Thus the communication device 102 can ensure that the encrypted data have indeed been received by the communication device 101 and not by another device that would attempt to pass itself off as the communication device 101.

In a following step 408, the communication device 102 checks the signed acknowledgement thanks to the key received at the step 403.

FIG. 5 schematically illustrates a second example of exchanges in the context of a sending of encrypted data by the communication device 102 toward the communication device 101 via the network 100.

In a step 500, the communication device 102 obtains the SAS string associated with the communication device 101, as during the step 400.

In a following step 501, the communication device 102 transmits to the communication device 101 a request aiming at obtaining the public encryption key of the communication device 101. This assumes that the communication device 102 has information for addressing the communication device 101, enabling the communication device 101 to be contacted.

It should be noted here that the authentication information derived from the public key, meaning the SAS string, is obtained before the public key is required. In other words, the information derived from the public encryption key of said recipient device is obtained independently of the obtaining of the key supposed to be the public encryption key of said recipient device.

In a following step 502, the communication device 101 retrieves its own public key and, in a following step 503, transmits it to the communication device 102.

In a following step 504, the communication device 102 checks the authenticity of the key received at the step 503, as described previously in relation to FIG. 2. In the case of positive checking, the communication device 102 encrypts the data to be transmitted to the communication device 101 thanks to the key obtained at the step 503.

The steps 505 to 508 are then performed, which correspond to the steps 405 to 408 described above in relation to FIG. 4.

1. A method for deciding on transmission of encrypted data to a recipient device, the method being implemented by a control device controlling a communication device, said method comprising:
obtaining a key supposed to be a public encryption key of said recipient device;
checking the obtained key, thanks to information derived from the public encryption key of said recipient device; and
authorising or prohibiting transmission, thanks to information for addressing the recipient device, of said data, encrypted thanks to the obtained key, according to said checking;
wherein the method comprises beforehand:
obtaining information derived from the public encryption key of said recipient device;
and wherein the information for addressing the recipient device is obtained by said control device thanks to the information derived from the key supposed to be the public encryption key of said recipient device.

2. The method according to claim 1, wherein obtaining the key supposed to be the public encryption key of said recipient device comprises:
transmitting, to a key server device, said information derived from the public encryption key of said recipient device, the key server device storing information on matching between the public encryption keys and information respectively derived from said public encryption keys; and
receiving, in response, the key supposed to be the public encryption key of said recipient device.

3. The method according to claim 2, wherein the key supposed to be the public encryption key of said recipient device is received in conjunction with the information for addressing the recipient device.

4. The method according to claim 1, wherein obtaining the key supposed to be the public encryption key of said recipient device comprises:
transmitting to the recipient device a request for obtaining the public encryption key from said recipient device; and
receiving, in response, the key supposed to be the public encryption key of said recipient device.

5. The method according to claim 1, wherein checking the obtained key comprises:
applying a predefined injective function to the key supposed to be the public encryption key of said recipient device, in order to obtain a result; and
checking that the obtained result is equal to the information derived from the public encryption key of said recipient device.

6. The method according to claim 5, wherein the information derived from the public encryption key of said recipient device is a fingerprint of the public encryption key of said recipient device.

7. The method according to claim 5, wherein the information derived from the public encryption key of said recipient device is derived from a fingerprint of the public encryption key of said recipient device.

8. The method according to claim 1, wherein the control device is included in the communication device.

9. The method for the transmission of encrypted data, to a device recipient of said encrypted data, by a communication device, wherein the communication device implements the method according to claim 1, and wherein said method further comprises:
transmitting the encrypted data in case of positive checking of the key supposed to be the public encryption key of said recipient device;
receiving a signed acknowledgement; and
checking the signed acknowledgement, thanks to the key supposed to be the public encryption key of said recipient device.

10. A control device for controlling a communication device, the control device being configured for:
deciding on transmission of encrypted data to a device recipient of said encrypted data;
obtaining a key supposed to be a public encryption key of said recipient device:
checking the obtained key, thanks to information derived from the public encryption key of said recipient device; and
authorising or prohibiting transmission of said data, encrypted thanks to the obtained key, according to said checking;
wherein the control device is further configured for:
obtaining, prior to obtaining the key supposed to be the public encryption key of said recipient device, the information derived from the public encryption key of said recipient device;
and wherein the control device is adapted for obtaining the information for addressing the recipient device thanks to the information derived from the key supposed to be the public encryption key of said recipient device.
